(19) United States
(12) Patent Application Publication
(10) Pub. No.: US 2025/0124135 A1
(43) Pub. Date: Apr. 17, 2025

(54) IMAGE PROCESSING APPARATUS AND FIRMWARE VERIFICATION METHOD

(71) Applicant: SHARP KABUSHIKI KAISHA, Sakai City (JP)

(72) Inventor: Masaki HIGASHIURA, Sakai City (JP)

(21) Appl. No.: 18/911,876

(22) Filed: Oct. 10, 2024

(30) Foreign Application Priority Data
Oct. 12, 2023 (JP) 2023-176855

(51) Int. Cl. G06F 21/57

(52) U.S. Cl. CPC G06F 21/572

(57) ABSTRACT

An image processing apparatus includes: one or more storages, each of which stores first firmware, second firmware differing from the first firmware, and a verification program used to verify presence or absence of falsification of the first firmware; and one or more controllers, each of which determines whether verification of at least the first firmware or the second firmware is enabled based on setting information set according to a security setting on the image processing apparatus. The one or more controllers verify presence or absence of falsification of the second firmware by the first firmware, which has been successfully verified by the verification program, in the case where the setting information is valid, and it is determined that the verification of the second firmware is enabled.

### CROSS-REFERENCE TO RELATED APPLICATION

The present application claims priority from Japanese Application JP2023-176855, the content of which is hereby incorporated by reference into this application.

### BACKGROUND OF THE INVENTION

### 1. Field of the Invention

The present disclosure relates to an image processing apparatus and the like.

### 2. Description of the Related Art

For example, in order to acquire Common Criteria (CC) certification of a hard copy device such as a multifunction peripheral, it is required to satisfy security requirements defined by collaborative Protection Profile for Hardcopy Devices (HCDcPP).

The security requirements defined by HCDcPP includes Secure Boot. Secure Boot is one of security functions for restricting execution of boot processing when falsification/damage (hereinafter, simply referred to as falsification) of firmware is detected at the time of activating a device.

For example, an information processing apparatus that reduces a verification time for verifying presence or absence of falsification of the firmware has been disclosed in the related art.

However, in the related art, verification processing of the firmware including a plurality of stages of Boot firmware and Main firmware is not taken into consideration.

### SUMMARY OF THE INVENTION

An object of the present disclosure is to provide an image processing apparatus and the like capable of efficiently executing verification processing of firmware including a plurality of stages.

In order to solve the above problem, an image processing apparatus according to the present disclosure includes: one or more storages, each of which stores first firmware, second firmware differing from the first firmware, and a verification program used to verify presence or absence of falsification of the first firmware; and one or more controllers, each of which determines whether verification of at least the first firmware or the second firmware is enabled based on setting information set according to a security setting on the image processing apparatus. The one or more controllers verify presence or absence of falsification of the second firmware by the first firmware, which has been successfully verified by the verification program, in the case where the setting information is valid, and it is determined that the verification of the second firmware is enabled.

A firmware verification method according to the present disclosure includes: storing first firmware, second firmware differing from the first firmware, and a verification program used to verify presence or absence of falsification of the first firmware; determining whether verification of at least the first firmware or the second firmware is enabled based on setting information set according to a security setting on an image processing apparatus; and verifying presence or absence of falsification of the second firmware by the first firmware, which has been successfully verified by the verification program, in the case where the setting information is valid, and it is determined that the verification of the second firmware is enabled.

According to the present disclosure can provide the image processing apparatus capable of efficiently executing verification processing of the firmware including a plurality of stages.

### BRIEF DESCRIPTION OF THE DRAWINGS

FIG. 1 is a perspective view of external appearance of a multifunction peripheral according to a first embodiment.

FIG. 2 is a diagram illustrating a functional configuration of the multifunction peripheral according to the first embodiment.

FIG. 3 is a view illustrating a memory map of nonvolatile memory.

FIG. 4 is a table illustrating verification flags according to the first embodiment.

FIG. 5 is a flowchart illustrating a flow of processing according to the first embodiment.

FIG. 6 is a view illustrating an operation example according to the first embodiment.

FIGS. 7A and 7B are views each illustrating the operation example according to the first embodiment.

FIG. 8 is a view illustrating the operation example according to the first embodiment.

FIG. 9 is a flowchart illustrating a flow of processing according to a second embodiment.

FIG. 10 is a table illustrating combinations of a condition of a verification flag and rewrite protection for realizing Secure Boot.

FIG. 11 is a table illustrating advantages of the present disclosure.

### DETAILED DESCRIPTION OF THE INVENTION

Hereinafter, embodiments of the present disclosure will be described with reference to the drawings. The following embodiments are merely examples for describing the present disclosure, and technical contents described in the claims are not limited to those in the following description.

The CC certification is a system for evaluating IT products based on the international security evaluation standard ISO/IEC15408. The CC certification is established to ensure security in procurement of private-sector products by the government. The CC certification is an international system that is mutually approved by 31 countries today.

In the CC certification, validity of a security function and validity of implementation thereof are evaluated by a third party (evaluation organization). The third party confirms that the evaluation was made based on the CC.

For example, HCDcPP is defined as security requirements specifications for earning the CC certification of a hard copy device such as a multifunction peripheral. HCDcPP includes Secure Boot, which is one of corresponding items required to comply with HCDcPP.

Secure Boot is one of security functions for restricting execution of boot processing when falsification of firmware is detected at the time of activating a device. In order to detect falsification of the firmware by Secure Boot, a program code to be executed first and encrypted data to be used for verification are protected from being rewritten by hardware as Root of Trust.

Root of Trust is unconditionally trusted, and the program code verified by a program (code) associated with Root of Trust is consequently trusted.

By the way, for detection of falsification of the firmware in the related art, a hardware device (secure microcomputer) serving as a base of Trusted Boot verifies presence or absence of falsification of the firmware that is stored in nonvolatile memory at the time of activating an information processing apparatus.

Here, in a configuration that the firmware is stored in the nonvolatile memory in a state of being divided into a plurality of stages of Boot firmware and Main firmware, in the related art, falsification of firmware (for example, Main firmware), verification of which is unnecessary when security settings of the information processing apparatus is invalid, is also detected. For this reason, the related art has a problem that an activation time of the information processing apparatus becomes long regardless of whether the security settings are valid or invalid.

The present disclosure realizes an image processing apparatus and the like capable of efficiently executing verification processing of firmware including a plurality of stages by the following embodiments.

### 1. First Embodiment

In a first embodiment, a description will be made on an embodiment in which Root of Trust protected by hardware is provided in advance by protecting a storage area for rewrite protection targets including a verification program code and a public key, which will be described below, from being rewritten at the time of factory shipment and firmware update.

### 1.1 Functional Configuration

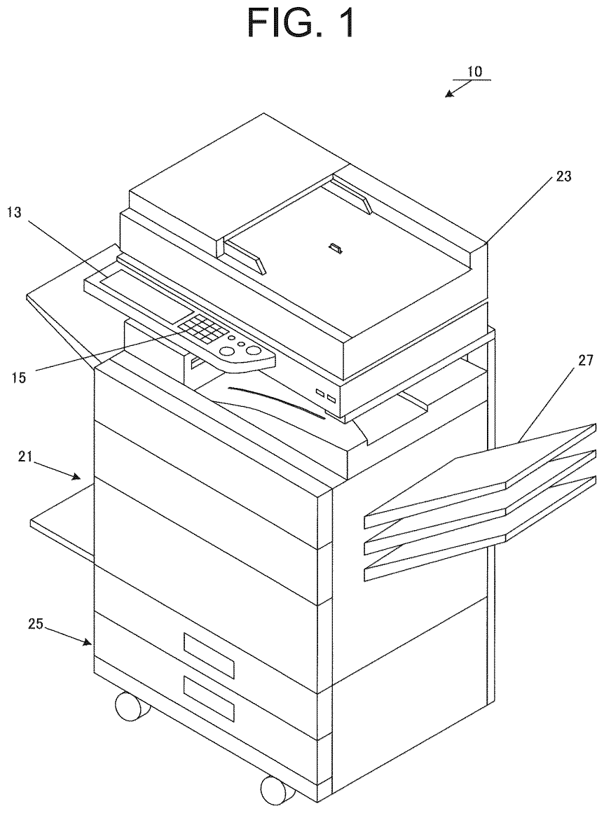

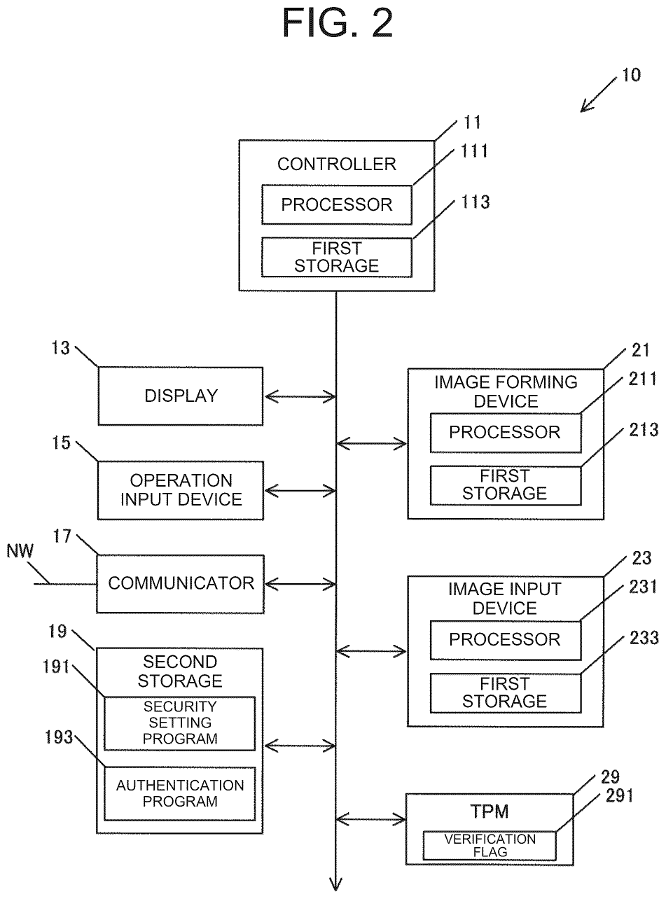

FIG. 1 is a perspective view of external appearance illustrating an overall configuration of a multifunction peripheral 10 as an image processing apparatus according to the first embodiment. FIG. 2 is a diagram illustrating a functional configuration of the multifunction peripheral 10.

The multifunction peripheral 10 is an example of the image processing apparatus capable of executing various types of jobs such as printing, copying, faxing, and image transmission in a single casing. The image processing apparatus according to the present disclosure is not limited to the multifunction peripheral 10 and may be an image processing apparatus such as a printer or a facsimile machine that is specialized for a specific function.

The multifunction peripheral 10 includes, as functional units, a controller 11, a display 13, an operation input device 15, a communicator 17, a second storage 19, an image forming device 21, an image input device 23, and a trusted platform module (TPM) 29.

The controller 11 controls the entire multifunction peripheral 10. The controller 11 includes: a processor 111 that includes one or more processing devices (for example, a central processing unit (CPU), a system on a chip (SoC), and the like); and a first storage 113 that stores firmware related to the controller 11.” The processor 111 can function as the controller 11 by controlling driving of hardware, which constitutes the controller 11, based on the firmware.

The processor 111 verifies the firmware by reading a verification program code stored in the first storage 113 in response to an input of a boot instruction of the multifunction peripheral 10. In the verification program code, a head code in a memory map of the first storage 113, which will be described below, is specified as a boot start address. When the boot instruction of the multifunction peripheral 10 is input, the processor 111 functions as the verification program by first reading the verification program code, and verifies the Boot firmware. The processor 111 determines whether it is enabled to perform verification of the firmware to be verified by the verification program code or firmware that has been successfully verified, based on validity/invalidity of a verification flag serving as setting information described below.

Meanwhile, in the case where a part of the first storage 113 that stores the verification program code and encrypted data (a public key) used for verification is protected from being rewritten by hardware as Root of Trust, the processor 111 verifies the Boot firmware regardless of the validity/invalidity of the verification flag for the Boot firmware described below. Next, when the Boot firmware is successfully verified, the processor 111 verifies the Main firmware based on validity/invalidity of a verification flag for the Main firmware described below.

Here, verification of firmware according to the present disclosure is intended to determine whether to permit activation (operation) of hardware based on the firmware, on the basis of processing to detect falsification of the firmware. In the present disclosure, a case where activation (operation) of the hardware based on the firmware is permitted by the verification of the firmware is referred to as that the firmware has been successfully verified. On the other hand, a case where the activation (operation) of the hardware based on the firmware is not permitted by the verification of the firmware is referred to as that the verification of the firmware has failed. The falsification according to the present disclosure is not limited to a malicious change of the firmware by a third party, but includes a change of the firmware with a specific intention by a user, an unintended change of the firmware that has accidentally occurred, and the like, and the change of the firmware is interpreted in the broadest sense.

For the verification of the firmware, for example, a digital signature method using a public key can be adopted. In the digital signature method, a software developer calculates a hash value of the entire firmware and signs the firmware with a private key. The firmware and the signature are written (stored) in the first storage 113 at the time of factory shipment or at timing of firmware update.

When the hardware is to be verified, the processor 111 compares the hash value calculated from the entire firmware with a hash value obtained by decrypting the signature using the public key. When the calculated hash value of the entire firmware matches the hash value obtained by decrypting the signature, the processor 111 determines that the firmware has been successfully verified. On the other hand, when the calculated hash value of the entire firmware does not match the hash value obtained by decrypting the signature, the processor 111 determines that the verification of the firmware has failed.

In the case where it is determined that the Boot firmware has been successfully verified, the processor 111 executes boot processing based on the Boot firmware. On the other hand, in the case where it is determined that the verification of the Boot firmware has failed, the processor 111 does not execute the boot processing based on the Boot firmware. In this case, for example, the processor 111 can notify a user of the multifunction peripheral 10 that the verification of the Boot firmware has failed by displaying an error number or an error content related to failure of the firmware on a touch panel described below, or the like. The processor 111 can also display contact information of a customer service on the touch panel. Furthermore, in the case where backup firmware is prepared separately from the Boot firmware related to the verification, the processor 111 may restore the Boot firmware, the verification of which has failed, from the backup firmware.

In the case where the Boot firmware is successfully verified, and the verification flag of the Main firmware is set to valid, the processor 111 verifies the Main firmware. In this way, it is possible to construct Chain of Trust for determining whether it is enabled to perform verification of the firmware (Main firmware) at the second stage onward by the Boot firmware at the first stage that has been verified by the verification program code serving as Root of Trust.

The first storage 113 is one or more storages that at least store the verification program code, the public key, the firmware, and the signature of the firmware. A type and a configuration of the first storage 113 are not limited as long as the content once written cannot be rewritten later (referred to as rewrite protection in the present disclosure). As the first storage 113, for example, nonvolatile memory such as mask read only memory (ROM), Programmable ROM (PROM), Erasable Programmable ROM (EPROM), Electrically Erasable and Programmable ROM (EEPROM), flash memory, Magnetoresistive Random Access Memory (MRAM), or Ferroelectric Random Access Memory (FRAM)® can be used.

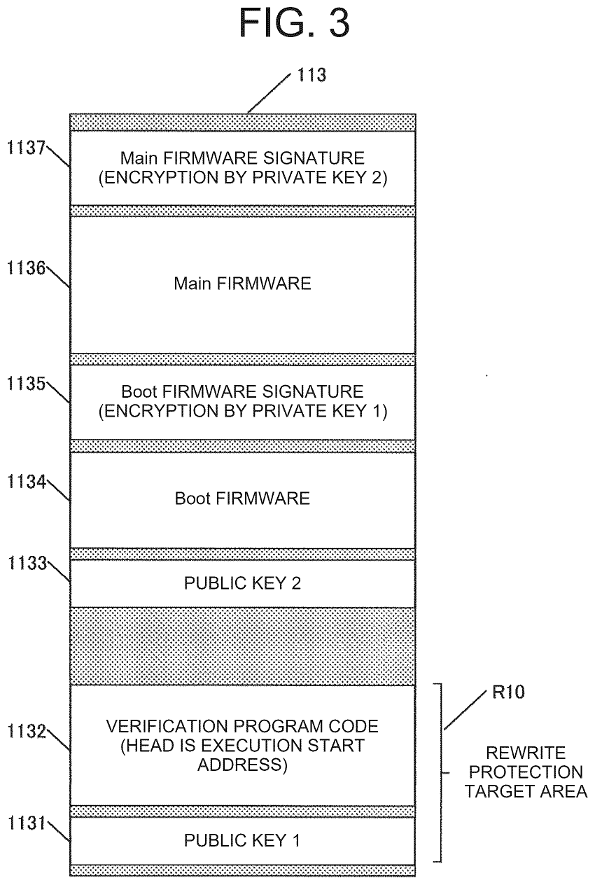

Here, an example of the memory map of the first storage 113 according to the present disclosure will be described with reference to FIG. 3. FIG. 3 is an image in which the firmware and the like are memory-mapped in the nonvolatile memory as the first storage 113.

As illustrated in FIG. 3, the first storage 113 stores a public key 1 (1131), a verification program code 1132, a public key 2 (1133), Boot firmware 1134, a Boot firmware signature 1135, Main firmware 1136, and Main firmware signature 1137.

The public key 1 (1131) is a private key for decrypting the Boot firmware signature 1135. The verification program code 1132 is a code of a verification program for verifying the Boot firmware 1134. A boot start address is specified at the head of the verification program code 1132. The activated processor 111 can function as the verification program by reading the verification program code 1132 from the boot start address.

The public key 2 (1133) is a private key for decrypting the Main firmware signature 1137. The Boot firmware 1134 is first firmware that functions as a verification program for verifying the Main firmware 1136. The processor 111 that has activated the Boot firmware 1134 executes the boot processing of the multifunction peripheral 10, such as specifying an address on the memory for reading the Main firmware 1136 and specifying hardware for activating the multifunction peripheral 10. The Boot firmware signature 1135 is a signature by a developer who has developed the Boot firmware 1134, and is encrypted with the private key paired with the public key 1 (1131).

The Main firmware 1136 is second firmware that controls driving of hardware constituting the controller 11 of the multifunction peripheral 10. The Main firmware signature 1137 is a signature by a developer who has developed the Main firmware 1136, and is encrypted with a private key paired with the public key 2 (1133).

In the first embodiment, a part of a storage area of the first storage 113, in which the verification program code 1132 and the public key 1 (1131) are stored, is set as a rewrite protection target area R10.

Referring back to FIG. 2, the display 13 is a display device that shows various types of information to the user and the like. The display 13 can be configured by, for example, a Liquid Crystal Display (LCD), an organic Electro-luminescence (EL) display or the like.

The operation input device 15 is an input device that accepts an input of information by the user or the like. The operation input device 15 can be configured by various input devices such as operation keys including hard keys and software keys and buttons, for example. The operation input device 15 can be configured as a touch panel that enables input via the display 13. In this case, for example, any of general methods such as a resistive film method, an infrared method, an electromagnetic induction method, and a capacitance method can be adopted as a touch panel input method.

The communicator 17 includes one or both of a wired interface and a wireless interface for communication with another device (a terminal device 30) via a network NW such as a local area network (LAN), a wide area network (WAN), the Internet, a telephone line, or a facsimile line. The communicator 17 may also include an interface related to a (short-range) wireless communication technology such as Bluetooth®, near field communication (NFC), Wi-Fi®, ZigBee®, Infrared Data Association (IrDA), or wireless USB.

The second storage 19 is one or more storage devices that store various programs and various types of data required for operation of the multifunction peripheral 10. The second storage 19 can be configured by a storage device such as random access memory (RAM), a hard disk drive (HDD), a solid state drive (SSD), or read only memory (ROM).

In the first embodiment, the second storage 19 stores a security setting program 191 and an authentication program 193.

The security setting program 191 is a program that is read by the controller 11 when accepting a setting input related to security for the multifunction peripheral 10. The controller 11 that has read the security setting program 191 functions as a setting unit that accepts a setting instruction (transition instruction) of a security setting from an administrator (user) via a system setting screen as an administrator screen described below. When accepting the selection instruction of the security setting from the administrator (user), the controller 11 shifts a security state of the multifunction peripheral 10 to an advanced security state. Here, the advanced security state refers to a security level at which the security state of the multifunction peripheral 10 at least satisfies an execution requirement of Secure Boot, and a setting for applying the security to the multifunction peripheral 10 is simply referred to as a “second security setting” in the present disclosure. Meanwhile, a setting for applying the security of a non-security state, where the security level is lower than that in the advanced security state or the security is not applied, to the multifunction peripheral 10 is simply referred to as a “first security setting” in the present disclosure.

The authentication program 193 is a program that is read by the controller 11 when the user who attempts to log in to the multifunction peripheral 10 is authenticated. The controller 11 that has read the authentication program 193 is operated as an authentication unit that is operated based on a user authentication function. When the user authentication function is valid, the controller 11 displays a login screen (not illustrated) on the touch panel, and accepts an input of authentication information related to user authentication by the user. For example, when an authentication condition is a combination of a login user name and a login password, the controller 11 stores in advance the login user name and the login password related to the user authentication in association with each other, and performs the user authentication by collating the login user name and the login password input via the login screen. In addition to knowledge authentication based on the combination of the login user name and the login password, the user authentication can be performed by possession authentication using a token, a key, an integrated circuit (IC) card, a smartphone, or the like, for example, biometric authentication such as face authentication or fingerprint authentication, or the like. The controller 11 can accept a setting to validate/invalidate the user authentication function from the administrator having management authority via the system setting screen described below or the like.

The image forming device 21 feeds paper from a paper feed tray 25, forms an image of image information related to a print job or the like on the paper, and then discharges the paper to a paper discharge tray 27. The image forming device 21 can be configured by a laser printer using an electrophotographic method, for example. In this case, the image forming device 21 forms the image by using toner supplied from toner cartridges (not illustrated), each of which corresponds to a respective toner color (for example, cyan, magenta, yellow, black, or the like).

The image forming device 21 includes, in addition to hardware required for image formation: a processor 211 that controls driving of the hardware; and a first storage 213 that stores firmware related to the image forming device 21. The processor 211 can function as the image forming device 21 by controlling the driving of the hardware required for image formation based on the firmware.

The processor 211 can have the same configuration as the processor 111 of the controller 11. The first storage 213 can have the same configuration as the first storage 113 of the controller 11 except for the stored firmware. Thus, the processor 211 and the first storage 213 will not be described herein.

The image input device 23 generates the image information by scanning a document. The image input device 23 includes an image sensor such as a charge coupled device (CCD) or a contact image sensor (CIS), and can be configured as an automatic document feeder (ADF) having a double-sided simultaneous document reading function or a scanner device having a flatbed for placing and reading the document. A configuration of the image input device 23 is not particularly limited as long as the image input device 23 can generate the image information by reading a reflected light image from the document image with an image sensor. The image input device 23 can also be configured as an interface capable of acquiring document information, which is stored in an external storage medium such as universal serial bus (USB) memory, and image information included in the print job transmitted from an external device.

The image input device 23 includes, in addition to hardware required for image input: a processor 231 that controls driving of the hardware; and a first storage 233 that stores firmware related to the image input device 23. The processor 231 can function as the image input device 23 by controlling driving of the hardware required for the image formation based on the firmware.

The processor 231 can have the same configuration as the processor 111 of the controller 11. The first storage 233 can have the same configuration as the first storage 113 of the controller 11 except for the stored firmware. Thus, the processor 231 and the first storage 233 will not be described herein.

The TPM 29 is a module that stores a verification flag 291 and the like as setting information and confirms that firmware held by the multifunction peripheral 10 has assumed contents and has not been falsified. As exemplified in FIG. 2, for example, the TPM 29 can be a separate component from the controller 11 by being configured as a dedicated chip on a control board (not illustrated), or may be implemented as a TPM function in the SoC that constitutes the controller 11. A storage mode of a verification flag 291 stored in the TPM 29 is not limited as long as the verification flag 291 is stored in an isolated secure storage environment other than the rewrite protection target storage area of the nonvolatile memory such as the first storage 113.

By providing the secure TPM 29 that stores the verification flag 291, unauthorized rewriting of the verification flag 291 from the outside becomes impossible, and thus, it is possible to prevent verification operation of the firmware from being avoided at the time of the second security setting.

The verification flag 291 is a flag identifier that is referred to by the processor 111 and the like in order to determine whether it is enabled to perform the verification of the firmware. In the case where the verification flag 291 is set to be valid, the processor 111 or the like verifies the firmware (for example, the Main firmware 1136). In the case where the verification flag 291 is set to be invalid, the processor 111 or the like restricts the verification of the firmware.

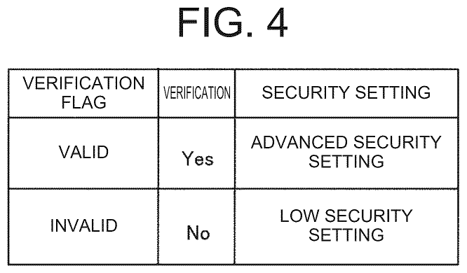

The verification flag 291 according to the present disclosure can be set based on the security setting on the multifunction peripheral 10. For example, as exemplified in the table of FIG. 4, when the security setting on the multifunction peripheral 10 is the second security setting (advanced security setting), the verification flag is set to be valid. In the case where the verification flag is set to be valid, for example, the processor 111 of the controller 11 verifies the Boot firmware 1134 or the Main firmware 1136 (VERIFICATION “YES”). On the other hand, in the case where the security setting on the multifunction peripheral 10 is the first security setting (low security setting), the verification flag is set to be invalid. In the case where the verification flag is set to be invalid, for example, the processor 111 of the controller 11 restricts the verification of the Boot firmware 1134 or the Main firmware 1136 (VERIFICATION “NO”).

Meanwhile, in the case where a part of the first storage 113 that stores the verification program code 1132 and the public key 1 (1131) used for the verification is protected from being rewritten by the hardware as Root of Trust, the processor 111 verifies the Boot firmware 1134 regardless of the validity/invalidity of the verification flag for the Boot firmware 1134.

By the way, the value of the verification flag 291 can be set in conjunction with the security setting by the (administrator) user via the system setting screen to be described below. For example, it is preferable that the setting of the value of the verification flag 291 is also automatically changed from “invalid” to “valid” when the security setting on the multifunction peripheral 10 is changed from the first security setting to the second security setting.

Just as described, by limiting the setting authority of the verification flag 291 to the (administrator) user, it is possible to prevent a non-administrator user from changing the setting of the verification flag 291 without permission.

### 1.2 Processing Flow

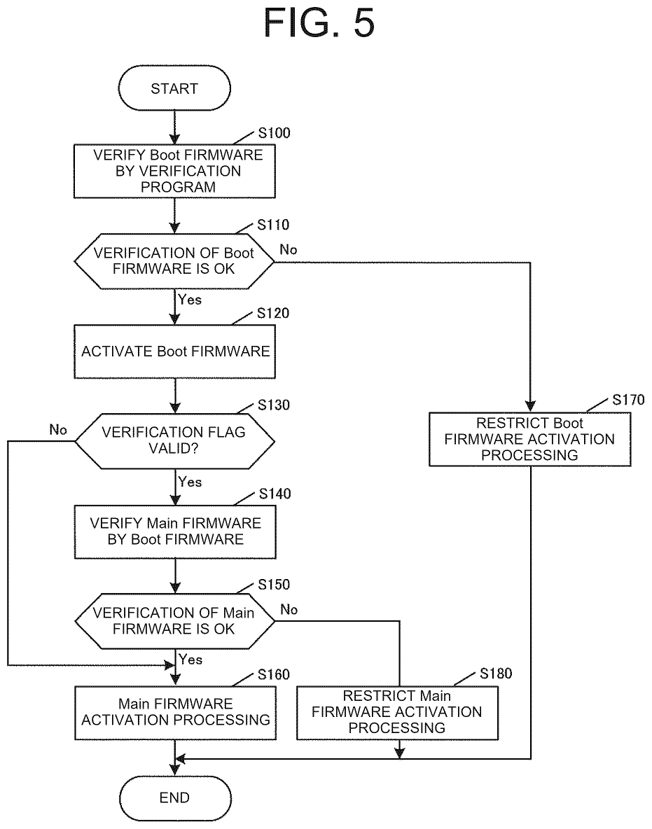

Next, a flow of processing according to the first embodiment will be described. FIG. 5 is a flowchart illustrating the processing according to the first embodiment. In the processing described with reference to FIG. 5, it is assumed that either the second security setting or the first security setting is applied to the multifunction peripheral 10. In the following description, it is also assumed that the verification flag 291 is set to “valid” or “invalid” based on the security setting on the multifunction peripheral 10. Furthermore, in the processing described with reference to FIG. 5, it is assumed that the rewrite protection is performed on the rewrite protection target area R10 that includes the verification program code 1132 and the public key 1 (1131) exemplified in FIG. 3 at least at the time of the factory shipment or the firmware update.

By the way, the verification of the firmware in each of the functional units including the controller 11, the image forming device 21, and the image input device 23 can be performed in the same manner among the functional units. Thus, in the following description, the verification of the firmware in the controller 11 will be described as an example.

When the boot instruction of the multifunction peripheral 10 is input, the processor 111 of the controller 11 reads the verification program code 1132 and starts the verification of the Boot firmware 1134 (step S100).

The processor 111 determines whether the verification of the Boot firmware 1134 has succeeded (step S110). If determining that the Boot firmware 1134 has been successfully verified, the processor 111 starts the boot processing of the Boot firmware 1134 (step S110; Yes→step S120). On the other hand, if determining that the verification of the Boot firmware 1134 has failed, the processor 111 restricts the boot processing of the Boot firmware 1134 and terminates the processing (step S110; No→step S170).

When starting the boot processing based on the Boot firmware 1134, the processor 111 determines whether the verification flag 291 for the Main firmware 1136 is valid (step S120→step S130).

If determining that the verification flag 291 for the Main firmware 1136 is valid, the processor 111 verifies the Main firmware 1136 by the activated Boot firmware 1134 (step S130; Yes→step S140).

Then, the processor 111 determines whether the verification of the Main firmware 1136 has succeeded (step S150). If determining that the Main firmware 1136 has been successfully verified, the processor 111 starts the boot processing of the Main firmware 1136 and terminates the processing (step S150; Yes→step S160). On the other hand, if determining that the verification of the Main firmware 1136 has failed, the processor 111 restricts the boot processing of the Main firmware 1136 and terminates the processing (step S150; No→step S180).

By the way, in step S130, if determining that the verification flag 291 for the Main firmware 1136 is invalid, the processor 111 executes the boot processing of the Main firmware 1136 without verifying the Main firmware 1136, and terminates the processing (step S130; No→step S160).

FIG. 5 illustrates an embodiment in which the processors 111, 211, 231, which are included in the functional units as the controller 11, the image forming device 21, and the image input device 23, respectively, each perform the verification of the firmware in the respective functional unit. The verification of the firmware in each of the functional units can be performed in series in an order of the controller 11, the image forming device 21, and the image input device 23, for example, in response to the input of the boot instruction of the multifunction peripheral 10. The firmware may be verified simultaneously (in parallel) in each of the functional units in response to the boot instruction of the multifunction peripheral 10.

By the way, when the processor 111 of the controller 11 supports multi-threading, the processor 111 of the controller 11 may verify the firmware of the image forming device 21 and the image input device 23. In this case, the processor 111 of the controller 11 preferably restricts the activation of the processor 211 of the image forming device 21 and the processor 231 of the image input device 23 until the firmware of the image forming device 21 and the image input device 23 is successfully verified.

Furthermore, a processor (microcomputer) that exclusively verifies the firmware may be provided separately from the processor 111 of the controller 11, the processor 211 of the image forming device 21, and the processor 231 of the image input device 23, and such a processor (microcomputer) may verify the firmware related to each of the functional units including the controller 11, the image forming device 21, and the image input device 23.

In the present disclosure, the firmware to be verified has been described as the firmware related to the controller 11, the image forming device 21, and the image input device 23. However, as other functional units, for example, firmware related to functional units related to facsimile transmission and image transmission can be added as the firmware to be verified.

### 1.3 Operation Example

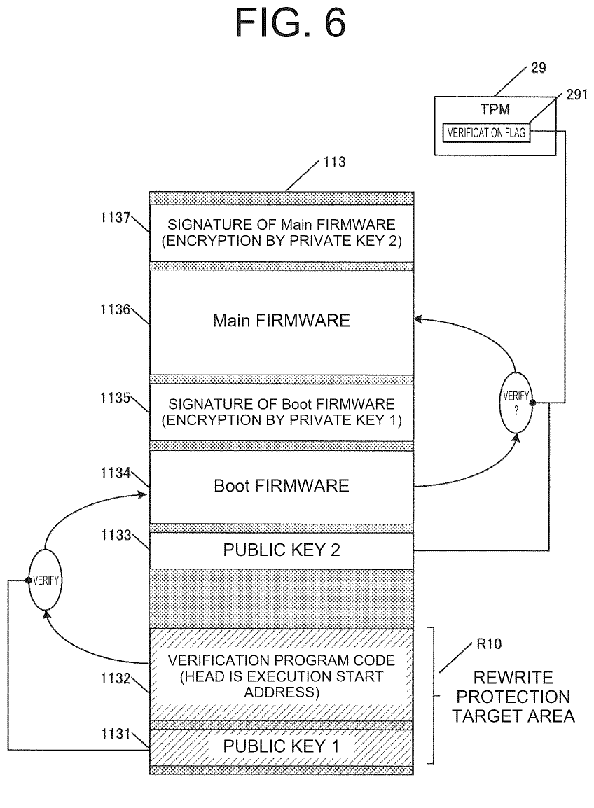

Next, an operation example according to the first embodiment will be described. FIG. 6 illustrates a state where the Main firmware 1136 is verified in Chain of Trust by the Boot firmware 1134, which has been successfully verified by the processor 111 having read the verification program code 1132, in the memory map of the first storage 113 illustrated in FIG. 3. A shaded portion in FIG. 6 represents a state where a part of the storage area of the first storage 113 including the verification program code 1132 and the public key 1 (1131) is protected as the rewrite protection target area R10.

The storage area including the verification program code 1132 and the public key 1 (1131) is protected as the rewrite protection target area R10. Consequently, the verification program code 1132 and the like obtain trust as Root of Trust. The verification program code 1132 as Root of Trust and the public key 1 (1131) are used to verify the Boot firmware 1134.

When the Boot firmware 1134 is successfully verified, the processor 111 verifies the Main firmware 1136 by the Boot firmware 1134 and the public key 2 (1133). At this time, the processor 111 determines whether to verify the Main firmware 1136 based on the verification flag 291 of the TPM 29.

For example, in the case where the security setting of the multifunction peripheral 10 is the second security setting, and the verification flag 291 is set to be valid, the processor 111 verifies the Main firmware 1136.

On the other hand, in the case where the security setting of the multifunction peripheral 10 is the first security setting, and the verification flag 291 is set to invalid, the processor 111 restricts the verification of the Main firmware 1136.

Just as described, in the first embodiment, when a part of the storage area of the first storage 113 including the verification program code 1132 and the public key 1 (1131) is protected as the rewrite protection target area R10, the verification of the Boot firmware 1134 is reliably performed. Meanwhile, in a situation where the security setting on the multifunction peripheral 10 is the first security setting and the verification of the Main firmware 1136 is not requested, the verification of the Main firmware 1136 is omitted (skipped), and the boot processing of the Main firmware 1136 is executed. Thus, it is possible to shorten a boot time of the multifunction peripheral 10.

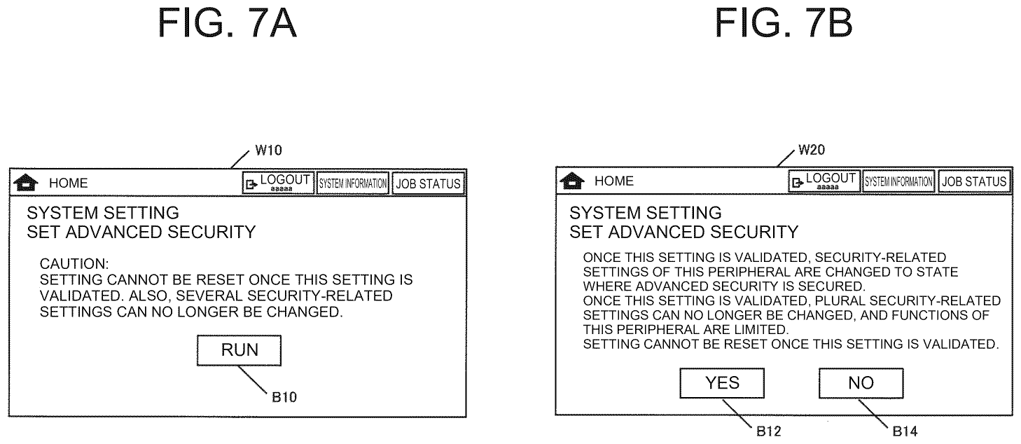

Next, FIG. 7A is a view illustrating an example of a screen configuration of a system setting screen W10 for accepting a setting instruction of the second security setting by the administrator (user).

The system setting screen W10 includes a “RUN” button B10 for accepting an execution instruction of the advanced security setting as the second security setting. The advanced security setting via the system setting screen W10 can be set to be valid by the administrator (user) having administrator authority who is authenticated by an authentication unit of the multifunction peripheral 10.

When the administrator (user) selects the “RUN” button B10, the system setting screen W10 is shifted to a system setting screen W20 illustrated in FIG. 7B.

The system setting screen W20 includes a “YES” button B12 and a “NO” button B14, in addition to a warning for a case where the multifunction peripheral 10 is brought into the advanced security state.

The “YES” button B12 is a button for accepting consent from the administrator (user) who has confirmed the warning. When the administrator (user) selects the “YES” button B12, the controller 11 performs the advanced security setting on the multifunction peripheral 10. On the other hand, the “NO” button B14 is a button for accepting a cancel instruction from the administrator (user). When the administrator (user) selects the “NO” button B14, the controller 11 does not perform the advanced security setting on the multifunction peripheral 10 (maintains the first security setting), and the processing is then terminated.

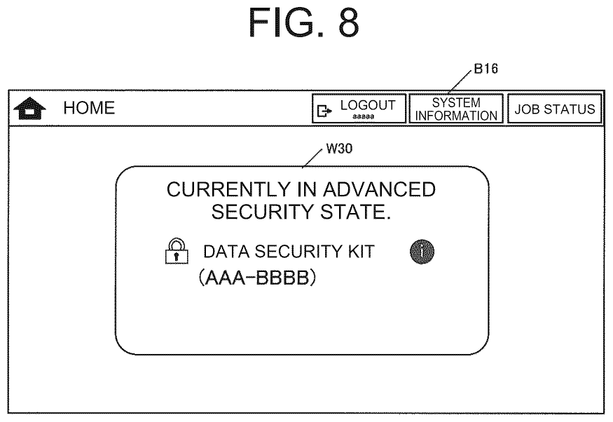

FIG. 8 is a display configuration example of a confirmation screen W30 for confirming the security state of the multifunction peripheral 10. Not only the administrator (user) but also a general user and a guest user can refer to the confirmation screen W30. When the user selects a system information button B16, the controller 11 displays the confirmation screen W30. On the confirmation screen W30, for example, when it is necessary to attach an optional device or the like in order to set the security state of the multifunction peripheral 10 (for example, “CURRENTLY IN ADVANCED SECURITY STATE.”) and, for example, the second security setting, a name of the optional device (for example, “DATA SECURITY KIT (AAA-BBBB)”) can also be shown.

As described so far, according to the first embodiment, it is possible to construct the Chain of Trust for verifying the firmware (Main firmware) at the second stage onward by the firmware (Boot firmware) at the first stage that is verified by the program code (verification program code), the trust of which is obtained by rewrite protected Root of Trust.

In a situation where the security setting on the multifunction peripheral is the first security setting and the verification of the Main firmware at the second stage onward is not requested, the verification of the Main firmware is omitted (skipped), and the boot processing of the Main firmware is executed. Thus, it is possible to shorten the boot time of the multifunction peripheral.

### 2. Second Embodiment

In a second embodiment, a description will be made on an embodiment in which the rewrite protection target storage area, which includes the verification program code described below and the public key, is not protected from being rewritten, and Root of Trust protected by the hardware is not provided in advance at the time of factory shipment and firmware update.

### 2.1 Functional Configuration

A functional configuration of a multifunction peripheral according to the second embodiment can be the same as that of the multifunction peripheral 10 according to the first embodiment. Thus, the description on the functional configuration of the multifunction peripheral 10 according to the second embodiment will be omitted, and the same reference numerals as those in the first embodiment will be used.

### 2.2 Processing Flow

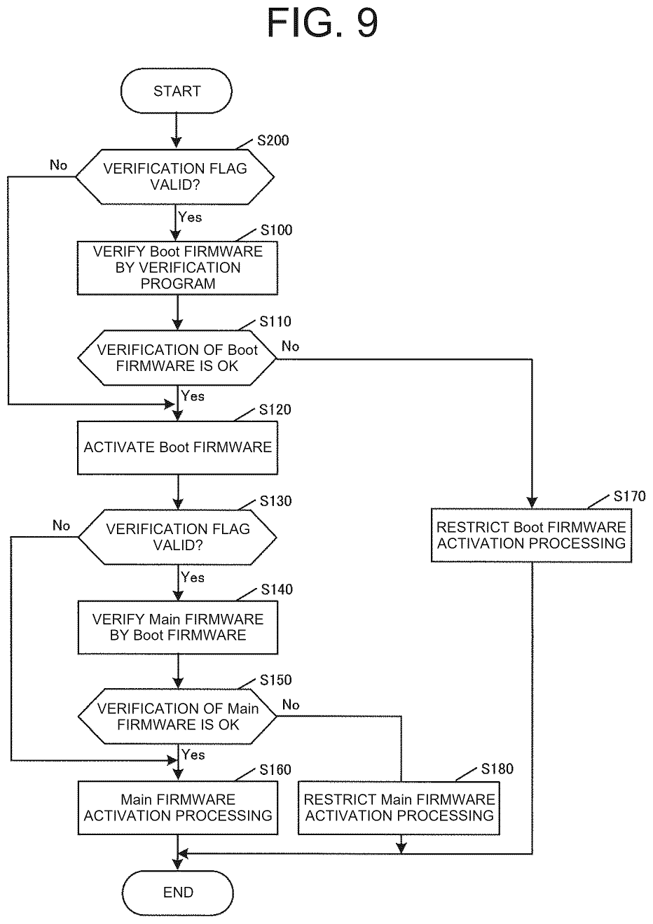

In regard to a flow of processing related to rewrite protection execution control according to the second embodiment, the flowchart in FIG. 5 is replaced with a flowchart in FIG. 9 by adding step S200. Thus, the same processing is denoted by the same step number, and the description thereon is omitted.

When the boot instruction of the multifunction peripheral 10 is input, the processor 111 of the controller 11 determines whether the verification flag 291 for the Boot firmware 1134 is valid (step S200).

If determining that the verification flag 291 for the Boot firmware 1134 is valid, the processor 111 executes processing related to step S100 and onward (step S200; Yes→step S100). On the other hand, if determining that the verification flag 291 for the Boot firmware is invalid, the processor 111 executes the boot processing of the Boot firmware 1134 without verifying the Boot firmware 1134 (step S200; No→step S120). Then, the processor 111 executes the processing in step S130 onward.

In the second embodiment, the rewrite protection for the rewrite protection targets such as the verification program code 1132 and the public key 1 (1131) can be performed at appropriate timing. For example, it is also possible to perform the rewrite protection of the rewrite protection targets at the same time as when the multifunction peripheral 10 is brought into the advanced security state.

As described so far, according to the second embodiment, in the situation where the security setting on the multifunction peripheral is the first security setting and the verification of the firmware is not requested, the verification of the firmware including the Boot firmware and the Main firmware is omitted (skipped), and the boot processing of the firmware is executed. Thus, it is possible to shorten the boot time of the multifunction peripheral.

In addition, according to the second embodiment, since the verification program code, the public key 1, and the like can be modified before the rewrite protection target storage areas are protected from being rewritten, it is possible to flexibly handle failure even when the failure occurs to these rewrite protection targets. After the rewrite protection, these rewrite protection targets cannot be changed. Thus, the reliability as Root of Trust can be obtained.

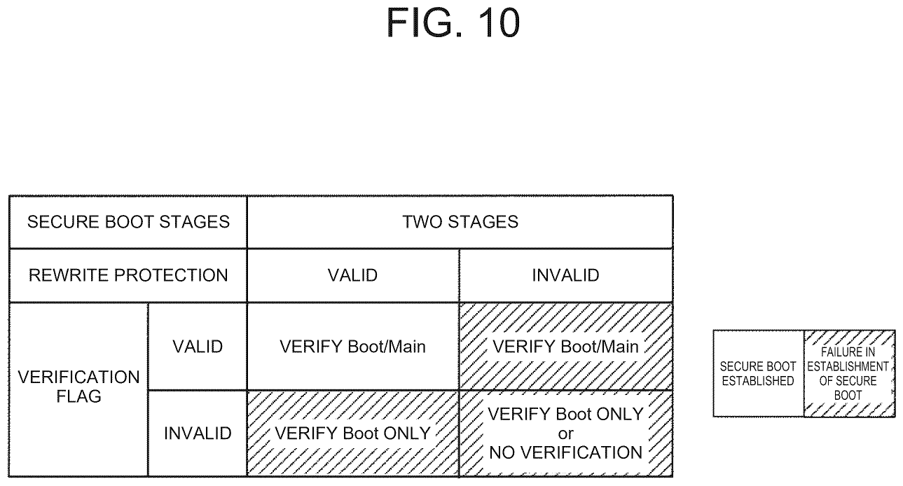

FIG. 10 is a table illustrating combinations of a condition of the verification flag 291 and the rewrite protection for realizing Secure Boot in the first embodiment and the second embodiment.

For example, in the case where the verification flag 291 is valid, and the rewrite protection is valid, the verification of the Boot firmware 1134 is performed by the verification program code 1132 and the like protected from being rewritten, and the verification of the Main firmware 1136 is performed by the Boot firmware 1134 that has been successfully verified. Thus, the condition satisfies the execution requirement of Secure Boot.

In the case where the verification flag 291 is valid, and the rewrite protection is invalid, even when the verification of the Boot firmware 1134 is performed by the verification program code 1132 and the like, which are not protected from being rewritten, and the verification of the Main firmware 1136 is performed by the Boot firmware 1134, which has been successfully verified, the above condition is the verification not based on Root of Trust. Thus, the execution requirement of Secure Boot is not satisfied.

In the case where the verification flag 291 is invalid, and the rewrite protection is valid, even when the verification of the Boot firmware 1134 by the verification program code 1132 and the like protected from being rewritten is successful, the verification of the Main firmware 1136 is not performed by the Boot firmware 1134, which has been successfully verified. Thus, the above condition does not satisfy the execution requirement of Secure Boot.

In the case where the verification flag 291 is invalid, and the rewrite protection is invalid, even when the verification of the Boot firmware 1134 by the verification program code 1132 and the like protected from being rewritten is successful, the verification of the Main firmware 1136 is not performed by the Boot firmware 1134, which has been successfully verified. Thus, the condition does not satisfy the execution requirement of Secure Boot.

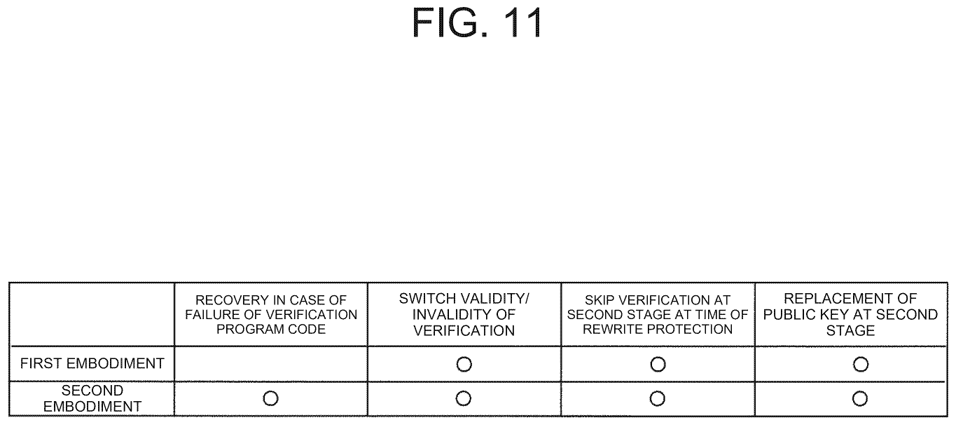

FIG. 11 is a table in which advantages of the first embodiment and the second embodiment are arranged.

In the first embodiment, the rewrite protection is performed on the rewrite protection target area R10 including the verification program code 1132 and the public key 1 (1131) at the time of the factory shipment or the firmware update. Thus, when the failure occurs to the verification program code 1132 or the like, the modification of the program code, changing of the private key (public key 1), and the like cannot be made. However, in the first embodiment, Root of Trust is unconditionally trusted, and the program code, which is verified by the program (code) related to Root of Trust, can eventually become reliable.

In addition, in the first embodiment, the validity/invalidity of the verification of the firmware can be switched by changing the setting of the verification flag 291. Furthermore, in the first embodiment, by invalidating the verification flag 291 for the Main firmware 1136, the verification at the second stage (Main firmware 1136) can be omitted (skipped). In this way, it is possible to shorten the time required for the boot processing of the multifunction peripheral 10. Moreover, in the first embodiment, since the public key 2 (1133) is not the rewrite protection target, the public key 2 (1133) can be replaced at appropriate timing. In this way, even when the public key 2 (1133) is falsified, the public key 2 (1133) can be replaced. Thus, the security can be maintained.

Meanwhile, in the second embodiment, in addition to the advantages according to the first embodiment, the verification program code 1132 and the like can be modified until the rewrite protection of the rewrite protection target is executed. Thus, even when the verification program code 1132 or the like is falsified, in the second embodiment, a falsified portion can be promptly modified, or the falsified verification program code 1132 or the like can be replaced.

The present disclosure is not limited to each of the above-described embodiments, and various modifications can be made. That is, the technical scope of the present disclosure also includes embodiments which are obtained by combining technical measures that are modified as appropriate without departing from the gist of the present disclosure.

Some parts of the above-described embodiments are described separately for convenience of the description. However, it is obvious that the embodiments may be combined to be executed within the technically possible range.

In addition, the program operated in each of the devices in the embodiments is a program (a program causing a computer to function) that controls the CPU or the like in a manner to implement the functions in the above-described embodiments. The information to be handled by these devices is temporarily accumulated in a temporary storage device (for example, RAM) during processing the information, and then stored in various storage devices such as read only memory (ROM) and an HDD, and is read, corrected, and written by the CPU as needed.

Here, the computer-readable non-transitory recording medium in which the program is recorded in the information processing apparatus may be any of semiconductor media (for example, a ROM, a nonvolatile memory card, or the like), an optical recording medium/magneto-optical recording medium (for example, a Digital Versatile Disc (DVD), a Magneto Optical Disc (MO), a Mini Disc (MD), a Compact Disc (CD), a Blu-ray® disc (BD), or the like), a magnetic recording medium (for example, a magnetic tape, a flexible disk, or the like), or the like. In this case, the program recorded in the recording medium is read by the computer of the information processing apparatus and executed by the computer, whereby not only that the functions of the above-described Embodiments are realized, but also that the functions of the present disclosure are realized by executing processing in cooperation with an operating system, another application program, or the like on the basis of instructions of the program.

Furthermore, in a case where the programs are to be distributed to the market, the programs may be stored in a portable recording medium for distribution or transferred to a server computer connected via a network, such as the Internet. In this case, needless to say, a storage device of the server computer is also included in the present disclosure.

In addition, each functional block or various features of the devices used in the above-described embodiment can be implemented or executed by an electric circuit, for example, an integrated circuit or a plurality of integrated circuits. The electric circuit designed to implement the functions described herein may include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor or a conventional processor, controller, microcontroller, or state machine. The above-described electric circuit may be configured by a digital circuit or an analog circuit. Moreover, when a technology for forming an integrated circuit which could substitute for the current integrated circuits emerges as a result of the progress of the semiconductor technology, one or more aspects of the present disclosure may also use new integrated circuits based on such technology.

What is claimed is:

1. An image processing apparatus comprising:
one or more storages, each of which stores first firmware, second firmware differing from the first firmware, and a verification program used to verify presence or absence of falsification of the first firmware; and
one or more controllers, each of which determines whether verification of at least the first firmware or the second firmware is enabled based on setting information set according to a security setting on the image processing apparatus, wherein
the one or more controllers
verify presence or absence of falsification of the second firmware by the first firmware, which has been successfully verified by the verification program, in the case where the setting information is valid, and it is determined that the verification of the second firmware is enabled.

2. The image processing apparatus according to claim 1, wherein
the one or more controllers
perform the verification of the first firmware by the verification program regardless of validity or invalidity of the setting information for the first firmware in the case where a part of an area of the one or more storages storing the verification program is protected from being rewritten.

3. The image processing apparatus according to claim 1, wherein
the one or more controllers
restrict the verification of the second firmware by the first firmware when the setting information for the second firmware is set to be invalid even in the case where the first firmware is successfully verified by the verification program.

4. The image processing apparatus according to claim 1, wherein
the one or more controllers
set the setting information to be invalid and restrict the verification of the second firmware by the first firmware in the case where the image processing apparatus is in a non-security state based on a first security setting, and
set the setting information to be valid and perform the verification of the second firmware by the first firmware in the case where the image processing apparatus is in a security state based on a second security setting.

5. The image processing apparatus according to claim 2, wherein
the one or more controllers
store the setting information in a storage area other than the area protected from being rewritten.

6. The image processing apparatus according to claim 1 further comprising:
a display that shows an administrator screen for accepting a transition instruction from a non-security state to a security state of the image processing apparatus.

7. The image processing apparatus according to claim 2, wherein
the one or more controllers
perform or restrict the verification of the first firmware by the verification program based on the setting information for the first firmware in the case where the part of the area of the one or more storages storing the verification program is not protected from being rewritten.

8. A firmware verification method comprising:
storing first firmware, second firmware differing from the first firmware, and a verification program used to verify presence or absence of falsification of the first firmware;
determining whether verification of at least the first firmware or the second firmware is enabled based on setting information set according to a security setting on an image processing apparatus; and
verifying presence or absence of falsification of the second firmware by the first firmware, which has been successfully verified by the verification program, in the case where the setting information is valid, and it is determined that the verification of the second firmware is enabled.
